(19) United States
(12) Patent Application Publication
(10) Pub. No.: US 2005/0213546 A1
(43) Pub. Date: Sep. 29, 2005

(54) Method and device for transmitting ip packets between a radio network controller (rnc) and another element of a mobile radio network

(76) Inventors: Johann Reitter, Berg im Attergau (AT); Alexander Vesely, Wien (AT)

Correspondence Address: MORRISON & FOERSTER LLP, 1650 TYSONS BOULEVARD, SUITE 300, MCLEAN, VA, 22102, US

(21) Appl. No.: 10/516,451

(22) PCT Filed: Jun. 7, 2002
(86) PCT No.: PCT/EP02/06268

§ 371 Date: Dec. 2, 2004

(51) Int. Cl. H04Q 7/24

(52) U.S. Cl. 370/338

(57) ABSTRACT

The invention relates to a method for transmitting IP packets between a radio network controller (RNC) (2) and another element of a mobile radio network. Said method is characterised in that an IP packet to be transmitted contains a first code-decoder mode indication (TFCI, AMR) which indicates the coder-decoder mode (TFCI, AMR) used to transmit the IP packet from a mobile terminal (MT) (1) to a first radio network controller (RNC) (2); a coder-decoder mode indication exchange system (DCF) (5) through which an IP packet passes on the way through the mobile radio network exchanges the first coder-decoder mode indication (RFCI, AMR) contained in the data packet, with a second coder-decoder mode indication (RFCI requested) which is known to another element or mobile terminal (MT) (1) and corresponds to the first coder-decoder mode indication according to a table stored in the coder-decoder mode indication exchange system (5); and the IP packet containing the second coder-decoder mode indication is sent on to other elements.

### CLAIM FOR PRIORITY

This application is a national stage of PCT/EP02/06268, published in the German language on Dec. 18, 2003, and was filed on Jun. 7, 2002.

### TECHNICAL FIELD OF THE INVENTION

The invention relates to a method and a device in a mobile communication network with which coder-decoder mode changes are implemented centrally in the case of IP packets to be exchanged between mobile radio users.

### BACKGROUND OF THE INVENTION

Conventionally, e.g. in GSM, a transmission channel between two codecs (coder-decoder) in a network has a fixed data rate. In response to certain conditions of the channel, e.g., the connection quality or depending on the data rate of the source, however, it is advantageous to change the channel data rate. This changing is performed by using AMR.

For example, two mobile stations are connected with each other via a mobile network. The first mobile station contains a first codec, and the second mobile stations contains a second codec. The codecs perform the necessary encoding/decoding for converting a voice signal into a digital signal which is transmitted via the network and vice versa. The codecs serve to provide a certain data rate. In case of AMR codecs, it is possible to switch this data rate to another data rate, for example, to 11.4 kbit/s on a so called “half rate channel”. This switching between the different data rates has to be performed simultaneously by both of the codecs involved.

However, coder-decoder changes are not implemented centrally in the case of IP packets to be exchanged between mobile radio users.

### SUMMARY OF THE INVENTION

The present invention discloses a method and a device such that a reduction in the signaling load is achieved by managing coder-decoder mode changes centrally. The transmission of IP packets between a Radio Network Controller (RNC) and another element of a mobile radio network has the advantage that the Radio Network Controller (RNC) does not have to know the coder-decoder mode(s) available currently and in the future. There is, therefore, no need for a software update at the Radio Network Controllers (RNC). The RNC (2) has to open an IP packet (user level IP packet) that is considered in its entirety as data. The RNC (2) therefore does not have to know how the data is structured. Nor does the RNC (2) have to know which RTP protocol header, IP protocol header, UDP protocol header and RTP payload header are used.

### BRIEF DESCRIPTION OF THE INVENTION

The invention is described in more detail with reference to exemplary embodiments shown in the Figures, in which:

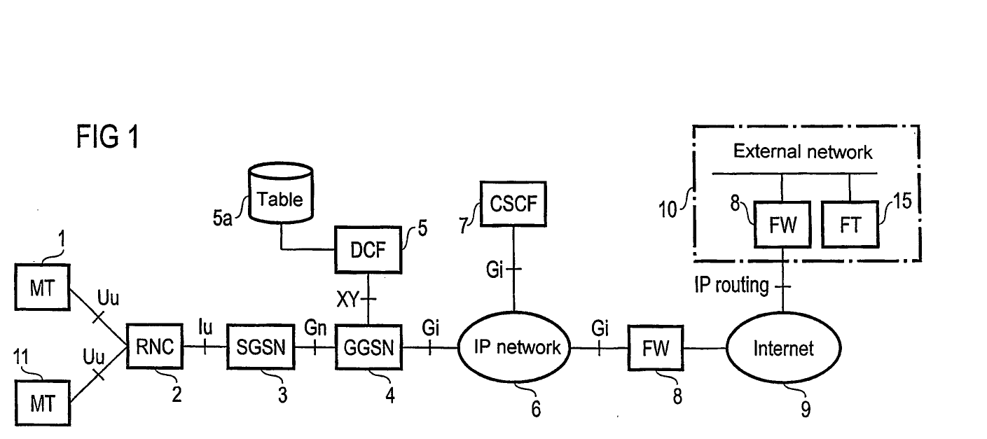

FIG. 1 shows an inventive network architecture with a device (DCF) to support a coder-decoder mode change.

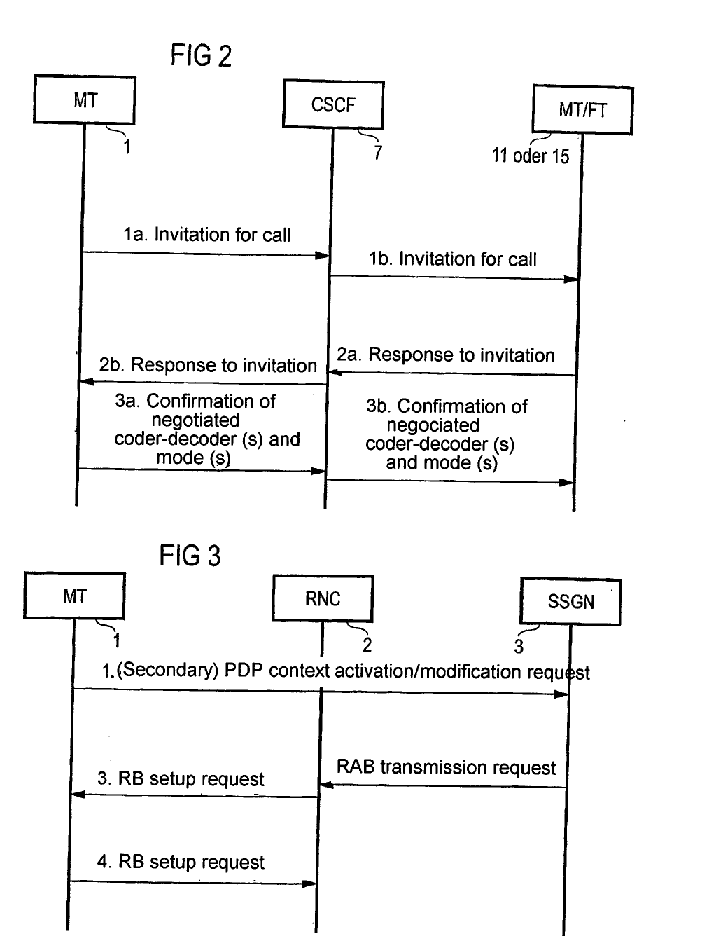

FIG. 2 shows data relating to the exchange of coder-decoder and mode in the event of a call.

FIG. 3 shows the integration of the access network.

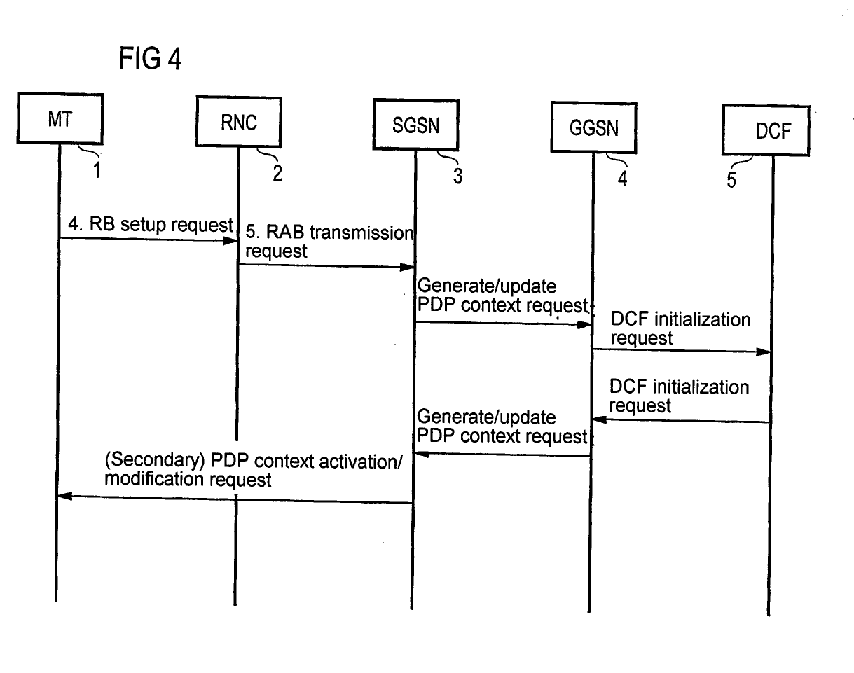

FIG. 4 shows the integration of the core network.

FIG. 5 shows the structure of an OCS frame (OCSF).

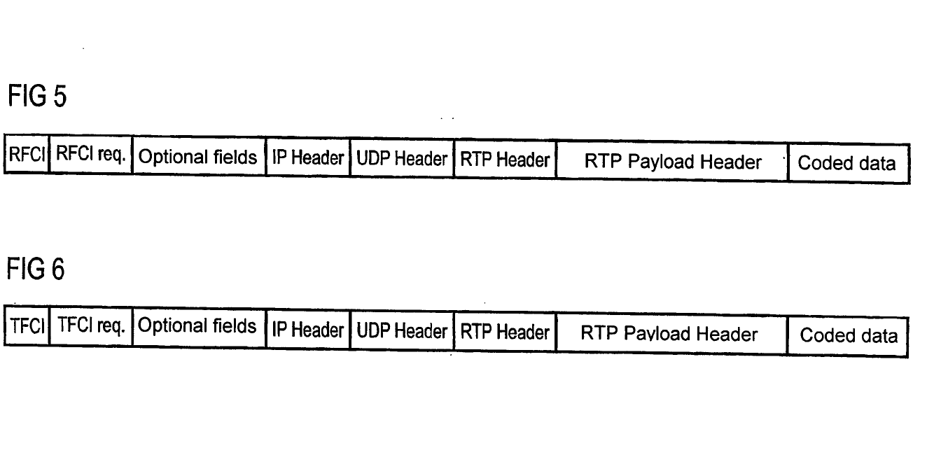

FIG. 6 shows the information from the RAB subflows used.

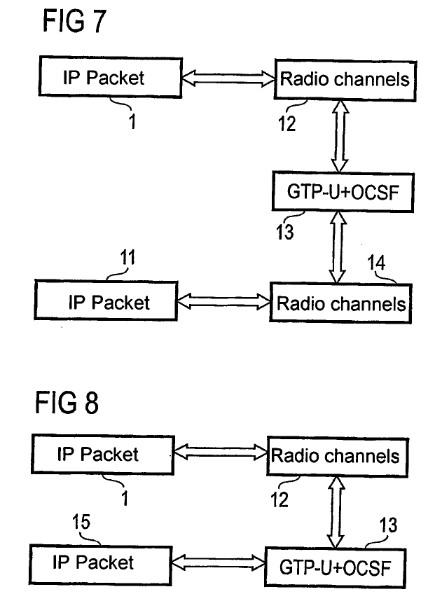

FIG. 7 shows the processing of an IP packet in the event of a call between two mobile terminals.

FIG. 8 shows the processing of an IP packet in the event of a call between a base station and a mobile terminal.

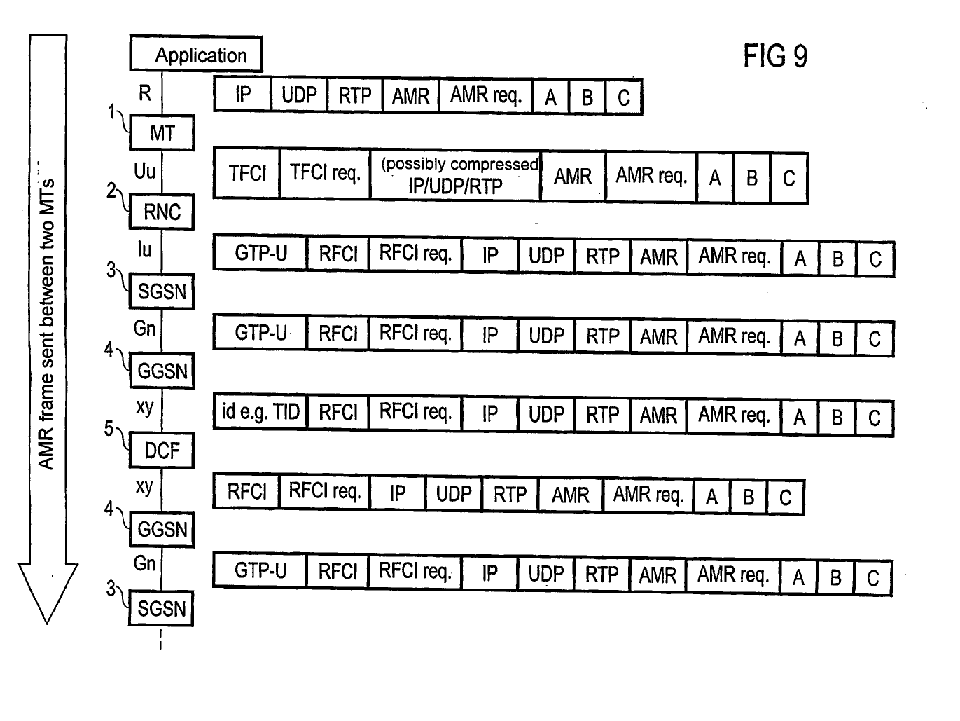

FIG. 9 shows the data packet at the individual stations for a call between two mobile terminals.

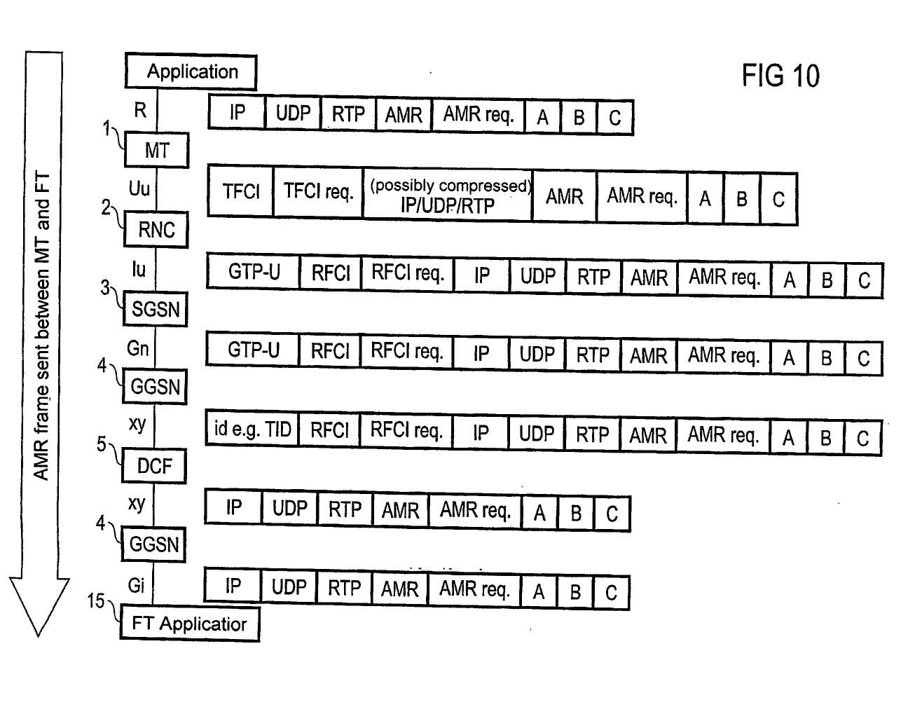

FIG. 10 shows the data packet at the individual stations for a call between a mobile terminal and a base station.

### DETAILED DESCRIPTION OF THE INVENTION

An IP packet is converted to an optimized codec support frame for transport between two radio network controllers and divided into different RAB subflows for transport between the radio network controller and the mobile terminal.

FIG. 1 shows the network architecture used for the method for transmitting IP packets between Radio Network Controllers (RNC) in the event of calls between mobile terminals. An IP packet (e.g. AMR coded voice) goes from a first mobile terminal (1) to the Radio Network Controller (2), where it is encapsulated in an OCS frame and is forwarded from there via the serving GPRS support node (3) to the gateway GPRS support node (4). A mobile terminal (1, 11) represents a mobile radio device, a hand-held computer, a mobile computer, a combination of the devices, etc. The RNC (2) has a table for this purpose, which is created dynamically as the connection is set up so that the TFCI value can be exchanged for the corresponding RFCI value and the TFCI req. value for the corresponding RFCI req. value. The RNC (2) is thereby given the information (RANAP: RAB assignment) that enables it to predefine the corresponding coder-decoder mode based on the current situation on the air interface. It is not necessary for the RNC (2) to know the coder-decoder mode but it does need to know its characteristics (e.g. required bandwidth). The OCS frame has the fields RFCI, RFCI req., optional fields and the IP packet, whereby the sequence of fields is determined in the implementation phase. Transport is effected for example by means of a GTP-U header, which is created by the RNC (2). The GGSN (4) forwards the OCS frame to the coder-decoder mode indication exchange system (DCF) (5) and the latter uses a table (5a) to verify the coder-decoder mode indication used and where necessary exchanges this for another. The OCS frame can thereby be transported between the GGSN (4) and the DCF (5) in one piece (one argument) or divided into different arguments (RFCI=argument 1, RFCI req.=argument 2, IP packet=argument 3). The coder-decoder mode indication exchange system (DCF) (5) can be integrated in a communication network as a central element or a non-central element. The DCF (5) can thereby be its own node, an element of the GGSN (4) or another node. In the case of a central DCF (5) the RFCI value is converted by the sender to the RFCI value of the recipient and the RFCI req. value of the sender to the RFCI req. value of the recipient. It is a further task of the DCF (5) to compare the requested coder-decoder mode (represented by the AMR req. value) with the RFCI req. value. If these are different, the DCF (5) exchanges the AMR req. value according to the RFCI req. value.

In the case of one DCF (5) per GGSN (4) the DCF (5) receives an RFCI value, an RFCI req. value and the IP packet from the GGSN (4). The DCF (5) then compares the AMR coder-decoder mode req. with the RFCI req. value and exchanges the AMR req. value, if the values do not correspond. For the recipient direction the IP packet is forwarded by the GGSN (4) on the basis of an indicator (e.g. TFT evaluation) to the DCF (5), where the AMR coder-decoder mode and the AMR coder-decoder mode req. are determined and replaced by the corresponding RFCI value and RFCI req. value. The difference between a central and a non-central DCF (5) is that in the case of a non-central DCF (5) a DCF invocation takes place twice for one call between two mobile terminals (1, 11). The exchange can for example be assigned by the RNC (2) as a function of load to the DCF (5) based on the RFCI req. value. The OCS frame is sent again to the GGSN (4) and forwarded to a recipient mobile terminal (11) via the individual nodes (SGSN) (3) and RNC (2). Decapsulation takes place again in the RNC (2). If the recipient is a base station (15), the IP packet is forwarded to this from the GGSN (4) or the DCF (5) itself via a firewall (8), the internet (9) and an external network (10).

FIG. 2 shows how the coder-decoder mode(s) used for a call are determined between two mobile terminals 1 and 11. It should be ensured here that a mobile terminal (1) has determined a bearer for the transport of, for example, SIP messages. SIP messages include a list of possible coder-decoder mode(s) to be negotiated from the point of view of the caller. The mobile terminal (1) sends a SIP message with for example SDP information containing the proposed coder-decoder mode(s). The SDP protocol is preferred for the transport of coder-decoder mode(s) but other protocols such as html or xml could also be used. The called mobile terminal (11) sends coder-decoder mode(s) with which it wishes to carry out the call in response. The call state control function (CSCF) (7) of the IP multimedia subsystem (IMS), which can be accessed via the IP network (6), can intervene during the determination of the coder-decoder mode(s) used, if coder-decoder mode(s) other than those proposed by the mobile terminals (1, 11) are to be used. The IP network represents what is known as the operator-specific IP network (3GPP 29061). Both mobile terminals are now ready for the transmission of coder-decoder mode(s), which can be implemented on both sides. In the case of AMR coded voice the mobile terminal must convert the coder-decoder mode(s) to be transmitted to for example SDU parameters. If the CSCF (7) or another node involved in the transmission of the coder-decoder mode(s) while the call is being set up has already converted coder-decoder mode(s) to SDU parameters, the SDU parameters have to be forwarded to the mobile terminals (1, 11) in order to improve the SDP or SIP protocol. The sequence of SDU parameters can be identical to the transmitted coder-decoder mode(s) in the SIP/SDP list, which contains the negotiated coder-decoder mode(s).

FIG. 3 shows the initialization of the access network. Here the SGSN (3) knows the coder-decoder mode(s) to be used for the call. This is achieved for example via SDU parameters. The 3GPP session management protocol procedures “Activate PDP context”, “Modify PDP context” or “Activate secondary PDP context” are extended for SDU parameter transmission (with the same sequence as the corresponding coder-decoder mode(s) of the coder-decoder mode(s) transmission, as expressed by the coder-decoder mode(s) at the SGSN (3). As a result the SGSN (3) does not know about the type of service, which means that the SGSN (3) does not have to be initialized with the different coder-decoder mode(s) that might be requested for a call. The SGSN (3) therefore knows nothing about the transmitted service. The RANAP (RAP allocation) request, which includes the SDU parameters assigned to the mobile terminals, is invoked by the SGSN (3) for the transmission. The RRC protocol message, which determines the RAB subflows according to the SDU parameters, is called by the RNC (2). The header fields (Transport Format Combination Identifier) TFCIs and (RAB SubFlow Combination Identifier) RFCIs in data packets are stored in the RNC (2) for the call according to the SDU parameters received. The sequence of TFCIs and RFCIs corresponds to the SDU parameters received. TFCIs and RFCIs are used to identify the coder-decoder mode(s), without the RNC (2) having knowledge of the coder-decoder mode(s). The RNC (2) therefore does not have to know anything about the transmitted services. When RAB subflow setup has been completed successfully, the RRC protocol message is sent by the RAB subflows that connection setup has been completed. The mobile terminals (1, 11), the RNC (2) and the DCF (5) are the entities which know how the RFCIs are mapped onto SDU parameters.

FIG. 4 shows initialization of the coder-decoder mode(s) in a core network. For calls between a base station and a mobile terminal as well as between two mobile terminals the DCF (5) knows which RFCIs stand for which SDU parameters. The mapping between RFCIs and their corresponding coder-decoder mode(s) and the conversion of an IP packet to an OCS frame are thereby prepared. Alternatively in the case of calls between two mobile terminals the DCF (5) can exchange the values of the RFCI and the requested RFCI, as the RNC (2) express a type of SDU parameter, which a specific coder-decoder mode with a different RFCI from the corresponding RNC (2), which operates the corresponding recipient mobile terminal (11). For simplification purposes, the RFCIs used should have the same sequence as the SDU parameters and the SIP/SDP associated coder-decoder mode(s). The DCF (5) uses a table to be able to convert the RFCIs and OCS frames to IP packets and vice-versa. The table includes the RFCIs and corresponding SDU parameters as well as the tunnel endpoint identifier for PDP contexts for mapping the corresponding RFCIs. Further to a positive response by means of the RRC call setup message, the RNC (2) responds with a RANAP message and adds the RFCIs and their significance for the call. The SGSN (3) sends the RFCIs and their significance to the GGSN (4) via a GTP-C extension header. On receipt the GGSN (4) sends the RFCIs and their significance to the DCF (5), where initialization takes place for the call. The DCF (5) is now prepared to store the RFCIs and to convert IP packets to OCS frames and vice-versa.

FIG. 5 shows the structure of an OCS frame. The coder-decoder mode used is by the RFCI value at the OCS frame. Further table fields in the data packet can be added optionally. However, they have to be such that they can be interpreted by the recipient. The IP header field contains the information for reconfiguring the IP packet header. Some OCS frame information could be transmitted via a GTP extension header but this depends on standardization or implementation in a network.

FIG. 6 shows the table information for division into different RAB subflows.

FIG. 7 shows how an IP packet is transmitted from a mobile terminal (1) via individual network nodes to another mobile terminal (11). An IP packet to be sent is divided by the mobile terminal (1) into different RAB subflows (12). The values for TFCI, TFCI req. and any further values are thereby filled in with values originating from the IP packet. The RAB subflows (12) transport the IP packet to the RNC (2). Header compression like the IP/UDP/RTP header via the air interface is optional. In the RNC (2) the value for TFCI is exchanged for the corresponding value for RFCI and the value for TFCI req. is exchanged for the corresponding value for RFCI req. The RNC (2) has an appropriate table or array for this. As a result the IP packets divided into RAB subflows (12) are converted to OCS frames. The GTP-U header is then created by the RNC and prefixed to the OCS frame (13) and forwarded via the Serving GPRS Support Node (SGSN) (3) to the Gateway GPRS Support Node (GGSN) (4). The GGSN (4) forwards the frame to the coder-decoder mode indication exchange system (DCF) (5). In the case of a central DCF (5) the DCF exchanges the RFCI and RFCI req. values between the two mobile terminals (1, 11). The DCF (5) also compares the AMR req. value in the IP packet with the RFCI req. value and exchanges it where necessary. Where there is one DCF (5) per GGSN (4) the DCF (5) removes the RFCI and RFCI req. value and overwrites the AMR req. value with the RFCI req. value. gives the IP packet back to the GGSN (4) and the latter adds the GTP-U header (plus the GTP-U extension header) and sends the packet in the direction of the recipient RNC (2) in the case of a call between two mobile terminals (1, 11). The IP packet is sent beforehand via the recipient GGSN (4) to the recipient DCF (5) and the RFCI and RFCI req. values negotiated for the mobile radio terminal (11) are set and sent again to the GGSN (4). If the recipient is a base station (15) the IP packet is forwarded immediately from the GGSN (4).

The GGSN (4) may exchange or modify the GTP-U header and send the OCS frame (13) to the SGSN (3), which forwards it to the RNC (2). The RNC (2) replaces the RFCI value with the corresponding TFCI value and the RFCI req. value with the corresponding TFCI req. value and divides the IP packet into a plurality of RAB subflows (14), which forward the IP packet via the air interface to the mobile terminal (11).

FIG. 8 shows the conversion and sending of an IP packet in the case of calls between a mobile terminal (1) and a base station (15). In the case of calls from a mobile terminal (1) to a base station (15) the DCF (5) converts an IP packet to an OCS frame and vice-versa. An IP packet, which is sent on the uplink (from the mobile terminal to the RNC), is divided by the mobile terminal (1) into RAB subflows (12) and forwarded to the RNC (2). The values for TFCI, TFCI req. and optional values thereby originate from the IP packet (AMR and AMR req. value). The IP data packet header and the encrypted data are also taken from the IP packet. Header compression e.g. the IP/UDP/RTP header via the air interface is, optional. The RNC (2) exchanges the TFCI value for the corresponding RFCI value and the TFCI req. value for the corresponding RFCI req. value. The RAB subflows (12) are thereby converted to an OCS frame. The GTP-U header is then prefixed to the OCS frame by the RNC (2) and forwarded via the SGSN (3) to the GGSN (4). The GGSN (4) decapsulates the OCS frame (13) and identifies, for example by a tunnel endpoint identifier of the GTP-U header, that the OCS frame should be sent to the base station (15) with GTP-U (13), which must be converted beforehand to an IP packet. For the conversion the GGSN (4) forwards the OCS frame (13) without the GTP-U header to the DCF (5). The DCF (5) converts the frame and sends it back to the GGSN (4). The IP packet is finally forwarded in the direction of the base station (15) by the GGSN (4). Alternatively the IP packet could be forwarded directly by the DCF (5) in the direction of the base station (15) without having to be sent back to the GGSN (4).

If the GGSN (4) receives an IP packet back from the base station (15), it is identified with a specific PDP context, according for example to the IP address or the TFT filter, if more than one PDP context is activated for the mobile terminal (1). The GGSN (4) knows from the identification that it has to forward the IP packet to the DCF (5), so that it can be converted there to an OCS frame. The IP packet is forwarded to the DCF (5) for conversion to an OCS frame together with an identifier, which interrogates the corresponding RFCIs and RFIC req., and is then sent back again to the GGSN (4). Next the GTP-U header is prefixed to the OCS frame and sent to the SGSN (3), which forwards the frame (13) to the RNC (2). After the GTP-U header has been removed, the RNC (2) exchanges the RFCI value for the corresponding TFCI value and the RFCI req. value for the corresponding TFCI req. value, divides the IP packet into RAB subflows (12) and sends it to the mobile terminal (1) which compiles it again.

Embodiment of a Coder-Decoder Mode Change Request at the Mobile Terminal

The request to digitize data with another coder-decoder mode is received in-band from the mobile radio network by an application in a mobile terminal, a computer, etc. A coder-decoder mode change is prompted by the RNC (2). This can be effected uplink by the mobile terminal (1, 11), which requests a specific coder-decoder mode by means of the TFCI req. value and is monitored by the RNC and downlink the recipient mobile terminal (1, 11) is requested via the RFCI req. value to use another coder-decoder mode. This value is monitored by the RNC (2) and if necessary corrected before it exchanges it for the TFCI req. value. It can also be prompted by the mobile terminal (e.g. with an RTP payload header field AMR req.), under the supervision of the RNC (2). On account of the air interface quality reports, which are sent by a mobile terminal (11) receiving coded data to the operating RNC (2), or by means of a trigger, e.g. the time, the RNC (2) can request a coder-decoder mode change from the sending mobile terminal (1), which is achieved by modifying the RFCI req. value of the OCS frame, which is sent to the sending mobile terminal. The RNC (2) can influence the request for a coder-decoder mode change via the SGSN (3) according to the current situation (e.g. bandwidth in current use and time). The mobile terminal receives a coder-decoder mode change request via the TFCI req. value. The application in the mobile terminal receives the same coder-decoder mode change request via a field value from the IP packet, such as the RTP payload header field AMR req. IF 1. The IP packet is then forwarded digitized with the requested coder-decoder mode to the lower layer (e.g. PDCP layer). The lower layer can interpret the field of the IP packet including information about the coder-decoder mode. As a result it verifies the IP packets received according to the coder-decoder mode that correlates with the TFCI req. value and either allows the IP packet to pass or rejects it. The mobile terminal codes data with the coder-decoder mode requested by the RNC (2). On the other hand, the quality of the call deteriorates dramatically due to lost packets.

Embodiment of a Coder-Decoder Change Request at the DCF

The DCF receives the coder-decoder change request in the form of an RFCI req. value. The application receives the same request in the form of a corresponding field in the IP packet. The application on a base station continues to code data with the requested coder-decoder mode received from the corresponding field in the IP packet. The IP packet is then sent to the DCF (5) with the requested coder-decoder mode via the GGSN (4).

As a result the DCF (5) verifies the coder-decoder mode in this received IP packet to determine whether it correlates with the RFCI req. value and either allows the IP packet to pass or rejects it. Transmission of the IP packet via the air interface can take place transcoded or not transcoded.

FIG. 9 shows the appearance of the data packet at the individual stations in the event of a call between two mobile terminals. The sequence of the fields is determined on the basis of implementation and standardization. The information (RFCI/TFCI value and AMR value, RFCI req./TFCI req. value and AMR req. value) about the coder-decoder mode is sent in duplicate in the present example. To eliminate this, the RTP payload header (contains AMR value and AMR req. value) is modified between the mobile terminal (1, 11) and the DCF, which means that an IETF protocol is changed.

FIG. 10 shows the appearance of the data packet at the individual stations in the event of a call between a mobile terminal and a base station. The sequence of fields is determined on the basis of implementation and standardization.

1. A method for transmitting IP packets between a Radio Network Controller and another element in a mobile radio network, comprising:
transmitting an IP packet that includes a first coder-decoder mode indication, which indicates the coder-decoder mode with which it was transmitted from a mobile terminal to a first Radio Network Controller;
a coder-decoder indication exchange system passed through by an IP packet via the mobile radio network, exchanging the first coder-decoder mode indication included in the data packet for a second coder-decoder mode indication corresponding to the first coder-decoder mode indication according to a stored table in the coder-decoder mode indication exchange system and known to the another element or mobile terminal; and forwarding the IP packet, which includes the second coder-decoder mode indication, the another element.

2. The method according to claim 1, wherein the
a Radio Network Controller (2) is used as the another element of a mobile radio network when a call between two mobile terminals occurs.

3. The method according to claim 1, wherein
an interface is used as the another element of a mobile radio network when a call between a mobile terminal and a base station occurs.

4. The method according to claim 1, wherein
during initialization of a connection between two mobile terminals, at least one first coder-decoder mode indication and associated second coder-decoder mode indication are stored in a table of a coder-decoder mode indication correspondence storage device.

5. The method according to claim 1, wherein
in a data packet coming from a mobile terminal and including a coder-decoder mode indication formed as a TFCI value and AMR value, the TFCI value is exchanged for a coder-decoder mode indication formed as an RFCI value by the Radio Network Controller receiving the data packet.

6. The method according to claim 5, wherein the TFCI indications and the RFCI indications represent a coder-decoder mode.

7. The method according to claim 1 wherein for calls between mobile terminals the Radio Network Controller can output SDU parameters, which represent a specific coder-decoder mode with an RFCI value, which is exchanged by the coder-decoder mode indication exchange system for the RFCI value and the requested RFCI value.

8. The method according to claim 5, wherein
the IP packet is converted to an Optimized Codec Support Frame format for transport in a GTP tunnel and divided into RAB subflows for transport between the Radio Network Controller and mobile terminal.

9. The method according to claim 8, wherein the coder-decoder mode is indicated in the Optimized Codec Support Frame by the RFCI value, the mode in which the data is coded is indicated in the Optimized Codec Support Frame by the RFCI requested value, a sequence of fields depends on implementation and standardization and other fields are added as required, if the recipient is initialized to interpret them.

10. The method according to claim 1, wherein an IP packet sent by a mobile terminal is divided into RAB subflows and provided with values for TFCI and TFCI requested and sent to the Radio Network Controller.

11. The method according to claim 8, wherein in the Radio Network Controller the TFCI value and the TFCI requested value are exchanged for the corresponding RFCI value and RFCI requested value of the Optimized Codec Support Frame.

12. The method according to claim 8, wherein a GTP-U header is prefixed to the Optimized Codec Support Frame by the Radio Network Controller and forwarded to a Gateway GPRS Support Node via a Serving GPRS Support Node.

13. The method according to claim 12, wherein
the Optimized Codec Support Frame is forwarded by the Gateway GPRS Support Node to the coder-decoder mode indication exchange system,
the corresponding RFCI values and RFCI requested values are aligned with the coder-decoder mode of the recipient mobile terminal,
the modified Optimized Codec Support Frame is sent back to the Gateway GPRS Support Node.

14. The method according to claim 12, wherein
the IP packet is modified by the coder-decoder mode indication exchange system,
the coder-decoder mode indication exchange system is called at least one further time by the Gateway GPRS Support Node to generate the Optimized Codec Support Frame, and
at least one Gateway GPRS Support Node is involved.

15. The method according to claim 12, wherein the GTP-U header is modified or exchanged by the Gateway GPRS Support Node and the Optimized Codec Support Frame is transmitted to the Serving GPRS Support Node, which forwards it to the Radio Network Controller, the RFCI value is exchanged by the Radio Network Controller for the corresponding TFCI value,
the RFCI requested is exchanged for the TFCI requested value or modified, and the IP packet is sent via the RAB subflows to the mobile terminal.

16. The method according to claim 12, wherein before it is sent to a base station the Optimized Codec Support Frame is converted by the coder-decoder mode indication exchange system to an IP packet,
the IP packet is sent by the coder-decoder mode indication exchange systems to the Gateway GPRS Support Node or directly in the direction of the base station.

17. The method according to claim 12, wherein
the coder-decoder mode change is initiated by the Radio Network Controller, and the coder-decoder mode change is initiated in the mobile terminal under the supervision of the Radio Network Controller.

18. A device for selecting data packets transmitted between terminals and coded with negotiated coder-decoder modes,
a table stored in a central coder-decoder mode indication exchange systems for comparing a first RFCI value with a second RFCI value;
an element for converting IP data packets to Optimized Codec Support Frames and for comparing listed RFCI values with RFCI values specified in the data packets; and
an element for converting Optimized Codec Support Frame back to IP data packets.

19. The device according to claim 16, wherein
the device is an element of a Gateway GPRS Support Node or another node.

20. The device according to claim 16, wherein the device is it own node with access via an IP protocol.
